(19) United States
(12) Patent Application Publication
(10) Pub. No.: US 2009/0017796 A1
(43) Pub. Date: Jan. 15, 2009

(54) METHODS AND SYSTEMS FOR COMMUNICATING BETWEEN IMS AND NON-IMS NETWORKS

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/775,078

(22) Filed: Jul. 9, 2007

(51) Int. Cl. H04M 3/42

(52) U.S. Cl. 455/414.1

(57) ABSTRACT

Systems and methods according to the present invention allow non-IMS end users to communicate with IMS networks (and vice versa). These cross network communications occur through a gateway which allows for identity mapping between the networks.

### TECHNICAL FIELD

The present invention relates generally to telecommunications systems and in particular to methods and systems for communicating between Internet Media Subsystems (IMS) networks and non-IMS networks.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally, cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structures of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other Internet Protocol (IP) networks) as a mechanism for providing traditional services. These multimedia services include IP television (IPTV, referring to systems or services that deliver television programs over a network using IP data packets), video on demand (VOD), voice over IP (VoIP), and other web related services received singly or bundled together.

To accommodate the new and different ways in which IP networks are being used to provide various services, new network architectures are being developed and standardized. IMS is an architectural framework utilized for delivering IP multimedia services to an end user. The IMS architecture has evolved into a service-independent topology which uses IP protocols, e.g., SIP signaling, to provide a convergence mechanism for disparate systems. In part this is accomplished via the provision of a horizontal control layer which isolates the access network from the service layer. Among other things, IMS architectures may provide a useful platform for the rollout of IPTV systems and services.

At a high level, an IMS/IPTV architecture is shown in FIG. 1(a). FIG. 1(a) includes a set-top box (STB) 18, a digital subscriber line access multiplexer (DSLAM), an IMS network 26 having a home subscriber server (HSS) 22 and a call session control function (CSCF) 24, and an IMS/IPTV application server (AS) 28. The STB 18 represents one or more IMS user and is in communication with a node such as DSLAM 20 which allows access to an IMS network 26 by aggregating signals from many STBs (not shown). IMS network 26 contains both the HSS 22 and the CSCF 24. The HSS 22 is a user database which contains subscriber information and can be used for authentication/authorization purposes within the IMS network 26. CSCFs process session initiation protocol (SIP) signaling packets and can be described as a proxy-CSCF (P-CSCF) which can be located in either the visited or home network and acts as a proxy, an interrogating-CSCF (I-CSCF) which is typically on the edge of a domain and is often used as a forwarding point, or a serving-CSCF (S-CSCF) which is a control node in the signaling plane. Also IMS network 26 is in communication with the IPTV AS 28 which provides the various IPTV service options available to the end user. Additionally, communication links exist between these devices and it is to be understood that more or fewer elements can exist in an IMS architecture, such as multiple CSCFs and other servers. More detail regarding IMS architecture generally and SIP signaling can be found in the Third Generation Partnership Project (3GPP) Technical Specification (TS) 23.228 Version 8 dated March 2007 and Request for Comments (RFC) 3261 dated June 2002 respectively.

In addition to IMS/IPTV networks, IPTV networks using other types of architectures are envisioned. For example, FIG. 1(b) illustrates a network having a legacy set-top box (STB) 10, a non-Internet Protocol Multimedia Subsystem (IMS)/IPTV network 14 and an IPTV AS 16. The legacy STB 10 represents devices such as STBs, browsers and IPTV client devices, which utilize a non-IMS protocol (such as hyper text transfer protocol (HTTP)) but are still capable of receiving IMS associated services. The non-IMS/IPTV network 14 is a communications network including routers, servers and the like that is capable of utilizing for example, HTTP for transporting IPTV signaling but not capable of utilizing certain protocols that are used on newer architectures, such as SIP, which is utilized in the afore-described IMS network architecture.

As IMS networks and associated services expand, users in non-IMS architectures (also referred to herein as legacy users) are expected to desire access to services provided through an IMS system, as well as access to other users and devices that utilize the IMS architecture. Extending IMS services to legacy users serve at least two objectives—it allows operators to continue to use their legacy STBs while being able to offer new revenue generating services for these subscribes, thus preserving the invested capital in old equipment, while at the same time it allows operators to deploy modern equipment that is more native to these services. To accomplish these goals legacy users must appear similar to IMS users. This means that the legacy users will need to have an IMS identity and utilize a registration process similar to those used by IMS users while keeping these processes transparent to the legacy user.

Accordingly, exemplary embodiments described below address the need for network entities and methods which facilitate communications between devices which utilize different network architectures, as well as network entities and methods which offer similar services transparently to devices that connect to different network architectures, or both.

### SUMMARY

Systems and methods according to the present invention address this need and others by providing techniques which facilitate communications between devices which utilize different network architectures, as well as techniques which offer similar services transparently to devices that connect to different network architectures, or both.

According to one exemplary embodiment a method for communicating between an IP Multimedia Subsystem (IMS) device and a non-IMS device includes: receiving, at a gateway node, a registration message from the non-IMS device; fetching an IMS identity; and transmitting a session initiation protocol (SIP) REGISTER message toward an IMS control node.

According to another exemplary embodiment a gateway node includes: a memory for storing IP Multimedia Subsystem (IMS) identities; a communication interface for receiving messages; and a processor in communication with the memory and the communication interface, wherein the gateway node receives a registration message associated with a non-IMS device, fetches an IMS identity associated with the non-IMS device, and transmits a session initiation protocol (SIP) REGISTER message.

According to yet another exemplary embodiment a method for initiating an IP Multimedia Subsystem (IMS) service from a non-IMS device, includes: receiving, at a gateway node, a hypertext transfer protocol (HTTP) request message for the IMS service from said non-IMS device; fetching an IMS identity associated with the non-IMS device; transmitting a session initiation protocol (SIP) message requesting the IMS service toward an IMS device; receiving a SIP message from said IMS device; transmitting a HTTP response message indicating acceptance of the IMS service toward the non-IMS device; and transmitting an acknowledgement message toward the IMS device.

According to yet another exemplary embodiment a method for receiving a message from an IP Multimedia Subsystem (IMS) device by a non-IMS device includes: receiving, at a gateway node, a session initiation protocol (SIP) message call from the IMS device; fetching a non-IMS identity associated with the non-IMS device; transmitting a hypertext transfer protocol (HTTP) request message including contents of the SIP message toward a non-IMS device; receiving a HTTP response message indicating successful receipt from the non-IMS device; and transmitting a SIP message indicating the successful receipt toward the IMS device.

According to yet another exemplary embodiment a method for requesting presence information from a non-IP Multimedia Subsystem (IMS) device regarding an IMS device includes: receiving at a gateway node, a hypertext transfer protocol (HTTP) request message for the presence information from the non-IMS device; fetching an IMS identity associated with the non-IMS device; transmitting a session initiation protocol (SIP) message requesting the presence information toward the IMS device; receiving a first SIP message indicating acknowledgement of the requesting from the IMS device; receiving a second SIP message including the presence information from the IMS device; transmitting an HTTP response message including the presence information to the non-IMS device; and transmitting an acknowledgement message toward the IMS device.

According to yet another exemplary embodiment a gateway node for providing IP Multimedia Subsystem (IMS) services to legacy users includes: logic for receiving a request for an IMS service from a legacy user; a web access interface capable of forwarding the request toward a first IMS application server; and an IMS access interface capable of forwarding the request toward a second IMS application server; wherein the logic selectively uses one of the web access interface and the IMS access interface to forward the request.

### BRIEF DESCRIPTION OF THE DRAWINGS

The accompanying drawings illustrate exemplary embodiments, wherein:

FIG. 1(a) illustrates Internet Protocol television (IPTV) communications between devices through an IP Multimedia Subsystems network;

FIG. 1(b) illustrates IPTV communications between devices through a non-IMS/IPTV network;

FIG. 2 depicts connecting a non-IMS/IPTV network with an IMS network according to exemplary embodiments;

FIG. 3 shows an IMS/IPTV gateway in communication with a non-IMS/IPTV network, an IMS network and associated devices, according to exemplary embodiments;

FIG. 4 shows a messaging sequence for registering a non-IMS/IPTV user in an IMS network according to exemplary embodiments;

FIG. 5 depicts a messaging sequence for a non-IMS/IPTV user to establish a voice over IP (VoIP) call according to exemplary embodiments;

FIG. 6 illustrates a messaging sequence for a non-IMS/IPTV user to receive a VoIP call according to exemplary embodiments;

FIG. 7 shows a messaging sequence for a non-IMS/IPTV user subscribing to the presence of an IMS user according to exemplary embodiments;

FIG. 8 shows a messaging sequence for a non-IMS/IPTV user receiving an incoming session initiation protocol (SIP) message from an IMS user, according to exemplary embodiments;

FIG. 9 shows a communications node according to exemplary embodiments; and

FIG. 10 shows a method for communicating between an IMS device and a non-IMS device according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

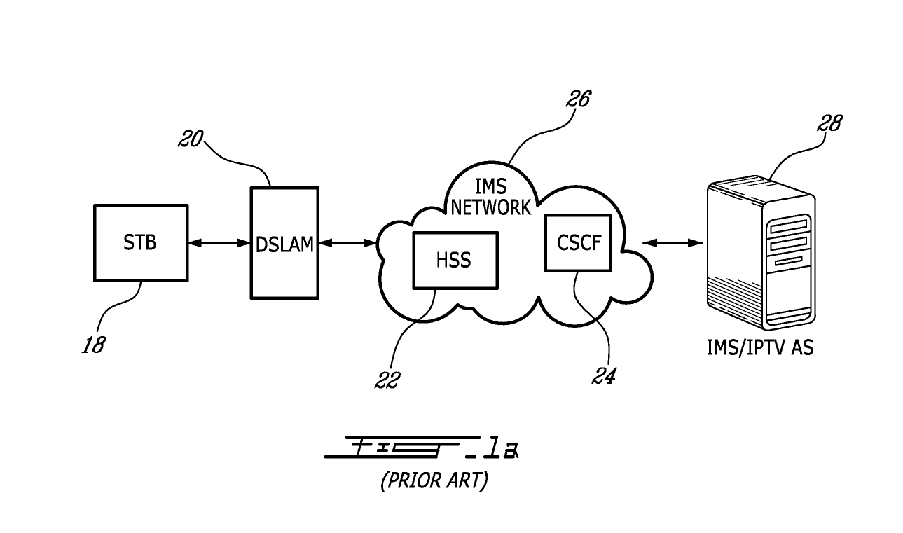

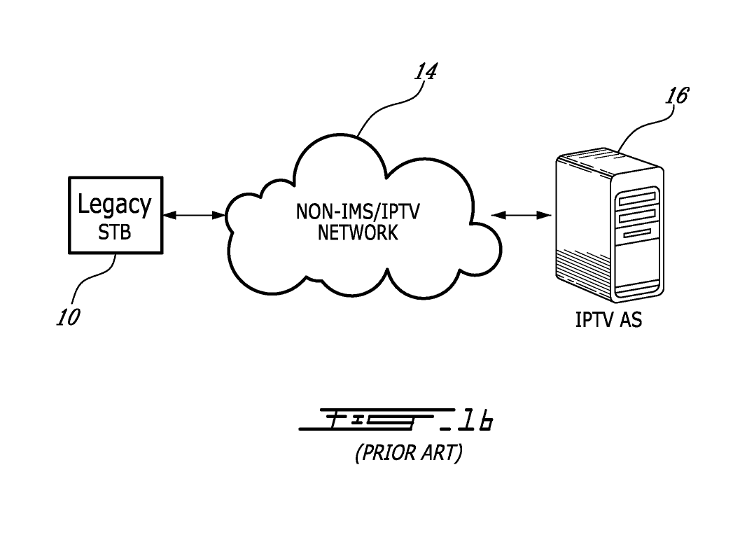

As described in the Background Section, Internet Multimedia Subsystems (IMS) is an architectural framework for delivering Internet Protocol (IP) multimedia services to an end user. IMS is an evolving, service-independent topology which uses IP protocols, e.g., Session Initiation Protocol (SIP) signaling, to provide a convergence mechanism for disparate systems. One way to differentiate between an IMS architecture and a non-IMS architecture is that devices in an IMS architecture typically have SIP endpoints which allow for SIP signaling to occur, whereas devices in a non-IMS system, e.g., the legacy STB 10 in FIG. 1(b), do not. SIP endpoints can be either hardware or software. Additionally, IMS is a standardized framework that offers/transports multiple person to person communication services, e.g., multimedia telephony and chatting, in a standard way, which is not necessarily the case in non-IMS architectures, and indeed some of these person to person communication services may not be offered at all.

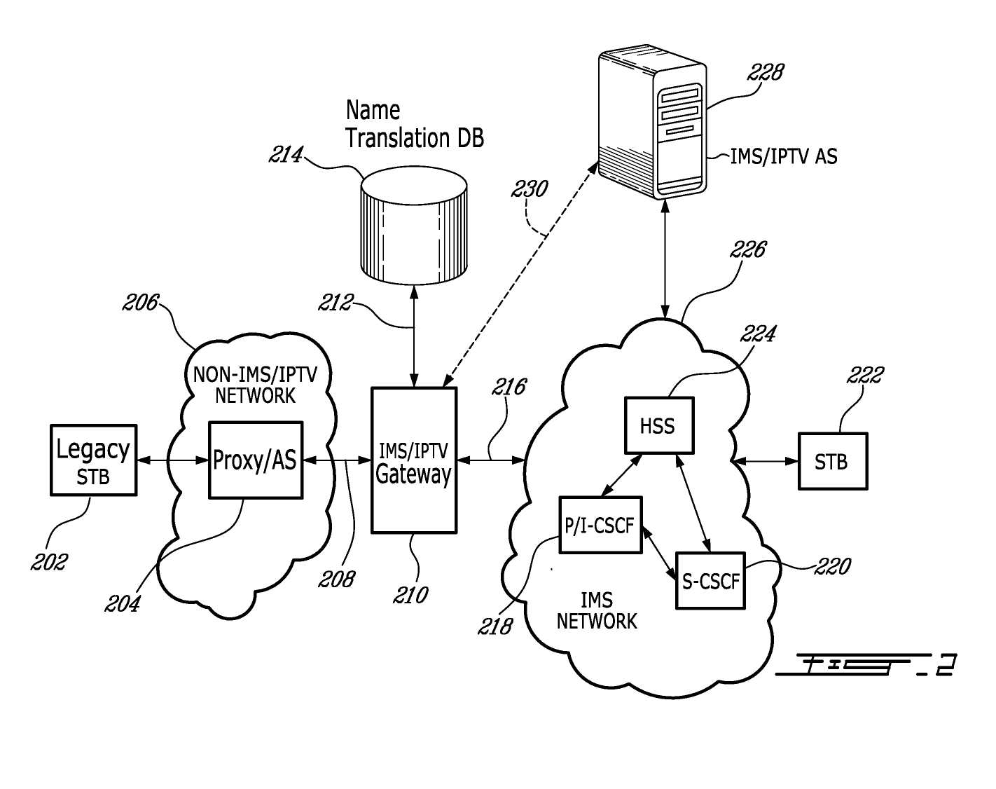

Users of devices that are associated with networks that utilize different architectures are expected to desire to be able to communicate with other devices, users and services in networks that utilize different architectures. For simplification, these “users” can be separated into two general categories: (1) IMS users and (2) non-IMS users (or legacy users). IMS users directly interface with an IMS system and can also be described as subscribers to the IMS system. Non-IMS users directly interface with a non-IMS system and can also be described as non-IMS subscribers. An exemplary embodiment that allows communications between devices (or users) in these different networks is illustrated in FIG. 2. Additionally, it is to be understood that the exemplary networks shown in FIG. 2 are purely illustrative and that the systems and methods described therein for transparently allowing users connected to different network architectures to communicate and seamlessly share services, e.g., IMS services, can be employed for other types of network architectures.

FIG. 2 includes a legacy STB 202 which is in communications with a proxy/AS 204 which is a node within a non-IMS/IPTV network 206. The proxy/AS 204 can be used to forward communications and to ensure that a non-IMS user desiring access to the IMS/IPTV gateway 210 is authorized for such access. The IMS/IPTV gateway 210 communicates with the proxy/AS 204, a name translation database (DB) 214 and an IMS network 226, through communication gateways/links 208, 212 and 216, respectively. These communication gateways/links 208, 212 and 216 are typically used by the IMS/IPTV gateway 210 for communicating with different networks and can support different protocols depending upon the network. For example, in this exemplary embodiment, communication gateway/link 208 supports Hypertext Transfer Protocol (HTTP), communication gateway/link 216 supports protocols used in an IMS network 226, e.g., session initiation protocol (SIP), and communication gateway/link 212 can support any protocols and messaging techniques used between the IMS/IPTV gateway 210 and the name translation DB 214. As will become more apparent from the discussion below, the IMS/IPTV gateway 210 and name translation DB 214 enable interworking between the non-IMS/IPTV network 206 and the IMS network 226.

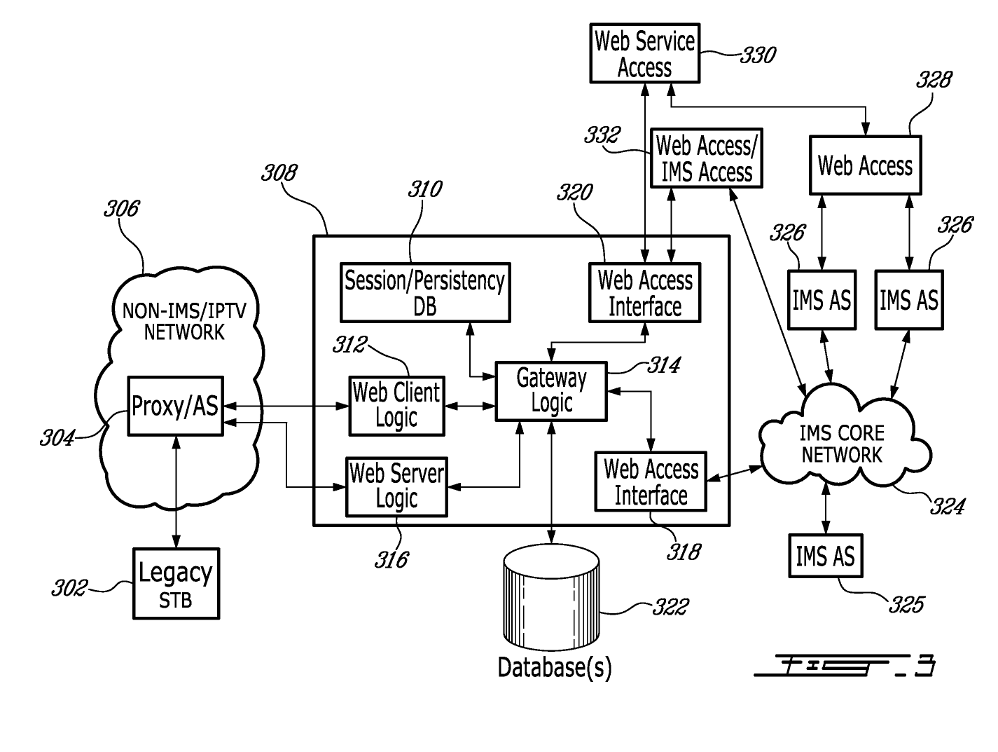

In addition to communicating with the IMS/IPTV gateway 210, the IMS network 226 communicates with the STB 222 and an IMS/IPTV AS 228. The IMS network 226 includes a proxy/interrogating call session control function (P/I-CSCF) 218, a home subscriber server (HSS) 224 and a serving call session control function (S-CSCF) 220. These components of the IMS network 226 are able to communicate with each other and to devices outside of the IMS network 226 as needed. The STB 222 typically is capable of utilizing the protocols used in the IMS network 226 and communicates with the IMS network 226. IMS/IPTV AS 228 contains media and/or IPTV services that can be offered through an IMS network 226 to end users. Additionally, IMS/IPTV AS 228 or other IMS ASs can have an alternate communication path 230 to the IMS/IPTV gateway 210. It is to be appreciated that more or fewer elements can exist in the networks and communication paths described. For example, more IMS/IPTV ASs 228 can be available, more or fewer nodes can exist in either the non-IMS/IPTV network 206 and/or the IMS network 226, and additional CSCFs can be utilized within the IMS network 226. Also, the IMS network 226 can include multiple domains that have communication links therebetween. An exemplary IMS/IPTV gateway 210 will now be described in more detail below with respect to FIG. 3.

According to exemplary embodiments, the IMS/IPTV gateway 308 includes various functional elements which allow user devices in dissimilar networks to be able to communicate with each other, and receive identical services as shown in FIG. 3. The IMS/IPTV gateway 308 can include a session/persistency database 310, a web client logic 312, gateway logic 314, a web server logic 316, an IMS access interface 318 and a web access interface 320. Gateway logic 314 provides a primary control mechanism for the gateway 308 according to this exemplary embodiment and communicates with all of the functional elements. More specifically, the gateway logic 314 receives incoming requests, interacts with the database(s) 322, and communicates with desired portions of the IMS network 324 through either the web access portal 320 or via IMS access interface 318 utilizing the native IMS protocol(s), e.g., SIP. A variety of services and devices can be accessed via either the IMS access portal 318 or web access portal 320 such as web service access 330, web access 328, the IMS ASs 326, web access/IMS access 332 and the IMS core network 324. These various access entities are described in more detail below.

This exemplary configuration provides for three different communication paths for a legacy user to access IMS related services. One communication path goes through the IMS/IPTV gateway 308 via the IMS access interface 318 and uses native SIP signaling. Various examples which use this communication path are provided below.

A second communication path goes through the IMS/IPTV gateway 308 via the web access interface 320. From web access interface 320 an HTTP request is established with the web service access 330, which implements the IMS web access to web access element 328. Web access element 328 allows for typical IMS services to be accessed through standard web techniques, which then allows for web service access 330 to perform data translation to map data from the IMS/IPTV gateway 308 to the data model of the IMS web access for the intended service.

The third communication path goes through the IMS/IPTV gateway 308 via the web access interface 320 to the web access/IMS access 322. Web access/IMS access 322 is able to communicate with both the web and the IMS core network 324 and additionally is able to utilize both native IMS signaling and standard web techniques. This third communication path is available for those IMS ASs 326 that can connect to both the web and an IMS network. This allows for additional flexibility by being able to receive service triggers through multiple paths. An appropriate communications path will be selected depending upon the communication options available. For example, IMS AS 325 might not have web access support, but only have access through the IMS core network 324 utilizing native SIP signaling. It will also be appreciated that more, fewer or different communication paths than those illustrated in FIG. 3 and described here could be provided.

The database(s) 322 includes the name translation database, which maintains mapped identities, and other databases containing desired user information relevant to the service being requested, e.g., information from an HSS 224. Each mapped identity stored in the database(s) 322 includes two parts according to this exemplary embodiment: (1) an identity for a user in the non-IMS/IPTV network 306, such as an HTTP Uniform Resource Identifier (URI) and (2) an identity for use in the IMS network, such as SIP URI. These paired identities may exist, for example, for each user (or device) that is associated with a non-IMS/IPTV network 306 to enable access to IMS services and vice versa for IMS devices/users to access the non-IMS/IPTV network 306.

The client logic 312 establishes a session with the proxy/AS 304 in order to send unsolicited information destined to the legacy STB 302. The server logic 316 receives incoming requests from the proxy/AS 304 on behalf of the legacy STB 302. The session/persistency database 310 holds the session state information that is used for different potential desired services such as telephony. As will be understood by one skilled in the art, the IMS/IPTV gateway 308 and its contained functions can be implemented through a variety of combinations of software and hardware (processors, memory, storage devices, etc.). An exemplary embodiment illustrating communications between the legacy STB 302 and an IMS AS 326 using the gateway 308 will be described below.

According to exemplary embodiments, the legacy STB 302 communicates with the proxy/AS 304, has been authorized to obtain IMS network access by the proxy/AS 304 and has been previously allocated an IMS identity which is stored in DB 322. This IMS identity allows the legacy user to look like an IMS user from an IMS network point of view with the gateway acting as the bridge for that purpose. Being an IMS user, the legacy user now has access to all IMS services like a regular IMS user. In this example, the legacy STB 302 transmits a message requesting a service provided by an IMS AS 326 to the proxy/AS 304 utilizing a non-IMS protocol, e.g., HTTP. The proxy/AS 304 forwards the request, including identifying information of the user, to the web server logic 312 within the IMS/IPTV gateway 308. This request is forwarded to the gateway logic 314 which uses the identifying information to index the database(s) 322. Upon a successful search, the identifying information is found along with an associated IMS identity. This is the IMS identity allocated to the legacy user. This information is transmitted back to the gateway logic 314. If the search fails, the user is unable to access the desired service provided by IMS AS 326, or any other IMS service. Once the IMS identity associated with the legacy user is received by gateway logic 314 a request is sent to the desired IMS AS 326. This communication request can be transmitted either through the web access interface 320 or the IMS access interface 318 as determined by the gateway logic 314 utilizing one of the communication paths described above depending upon, e.g., whether a particular IMS AS whose service is requested can be reached via web access or not in addition to other policies that may be deemed appropriate.

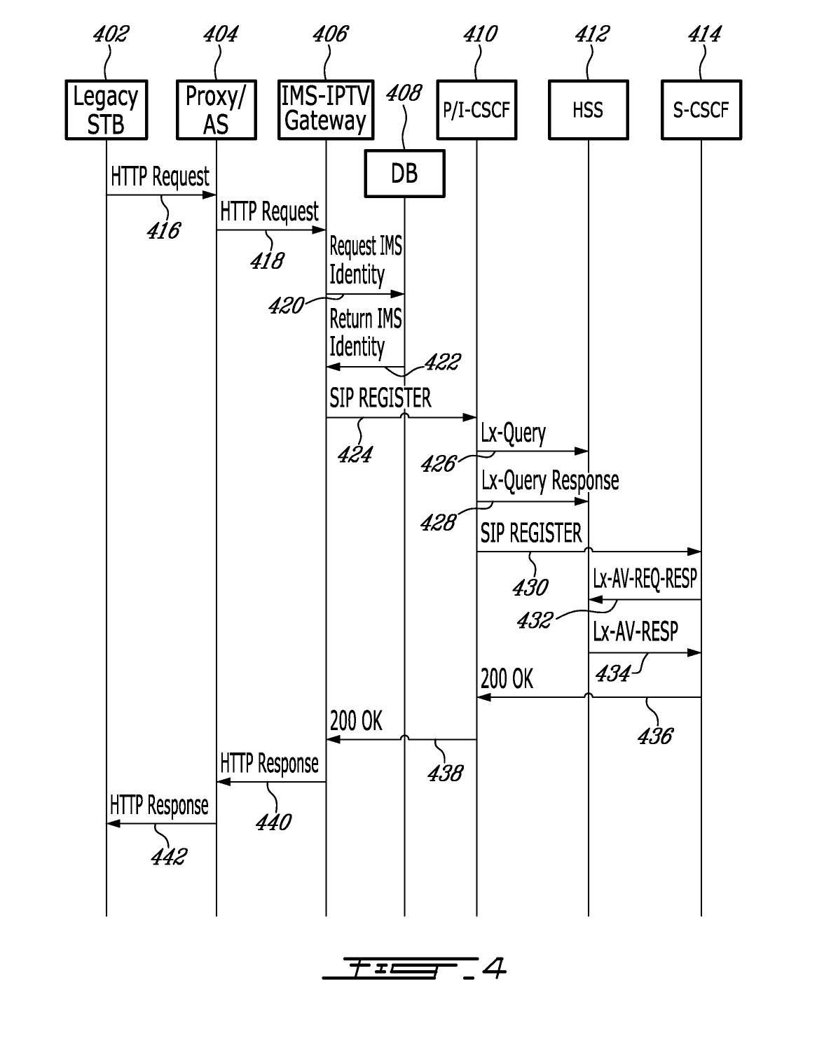

When the IMS/IPTV gateway 308 receives a response communication, including an IMS identity, through either web access 320 or IMS access 318, the gateway logic 314 takes the received IMS identity/session identity and uses the database(s) 322 or 310 to identify the user or device associated with the non-IMS/IPTV network to which the communications needs to be delivered. Alternatively, the earlier performed search results can be stored in a local memory within IMS/IPTV gateway 308 until the response communication is received. This information is then sent to proxy/AS 304 which forwards it to the legacy STB 302. Upon completion of this exemplary process, media can be sent from the desired IMS AS 326 to the legacy STB 302. Exemplary embodiments for transmitting messages (and in support of services) between devices associated with the non-IMS/IPTV network 306 and the IMS core network 324 will be described below with respect to the exemplary call flow diagrams shown in FIGS. 4-8. These processes can be performed using the exemplary architectures and devices described in FIGS. 2 and 3. It is to be understood that these exemplary call flows are purely illustrative examples of some of the IMS services available. More IMS services, both currently available and future services, can be expected to be available to legacy users utilizing methods and systems as described through FIGS. 2-8. Additionally, the exemplary call flow diagrams as shown in FIGS. 4-8 are described using only the first communication path described above (native IMS signaling) but it will be appreciated that the other communication paths described with respect to FIG. 3 can also be used.

FIG. 4 illustrates an exemplary sequence of messages used to register a legacy user through legacy STB 402 with an IMS system for a user that has a previously allocated IMS identity. IMS registration for a legacy user is generally a prerequisite before the legacy user can receive or initiate any IMS service. Initially, the legacy STB 402 transmits an HTTP request message 416 to a proxy/AS 404. Both the legacy STB 402 and the proxy/AS 404 are located in a non-IMS/IPTV system. Upon receipt of the HTTP request message 416, the proxy/AS 404 authenticates the user and the proxies the request 418 to the IMS/IPTV gateway 406. The IMS/IPTV gateway 406 then fetches the equivalent IMS identity, by transmitting a request message 420 to the database 408 and then receiving a message 422 containing the IMS identity from the database 408. The IMS/IPTV gateway 406 transmits a SIP REGISTER message 424 to the P/I-CSCF 410. The P/I-CSCF 410 then transmits a Cx-Query message 426 to the HSS 428. The HSS 428 validates the query and then transmits a Cx-Query Response message 428 back to the P/I-CSCF 410. The P/I-CSCF 410 then transmits a SIP REGISTER message 430 to the S-CSCF 414 allocated to the user by the I-CSCF. The S-CSCF 414 then communicates with the HSS 412 through Cx-AV-REQ-RESP message 432 and Cx-AV-RESP message 434. At this point, the legacy STB 402 is successfully registered within the IMS network 226 and the S-CSCF 414 begins the communications sequence to notify the legacy STB 402 of a successful registration with the IMS network 226.

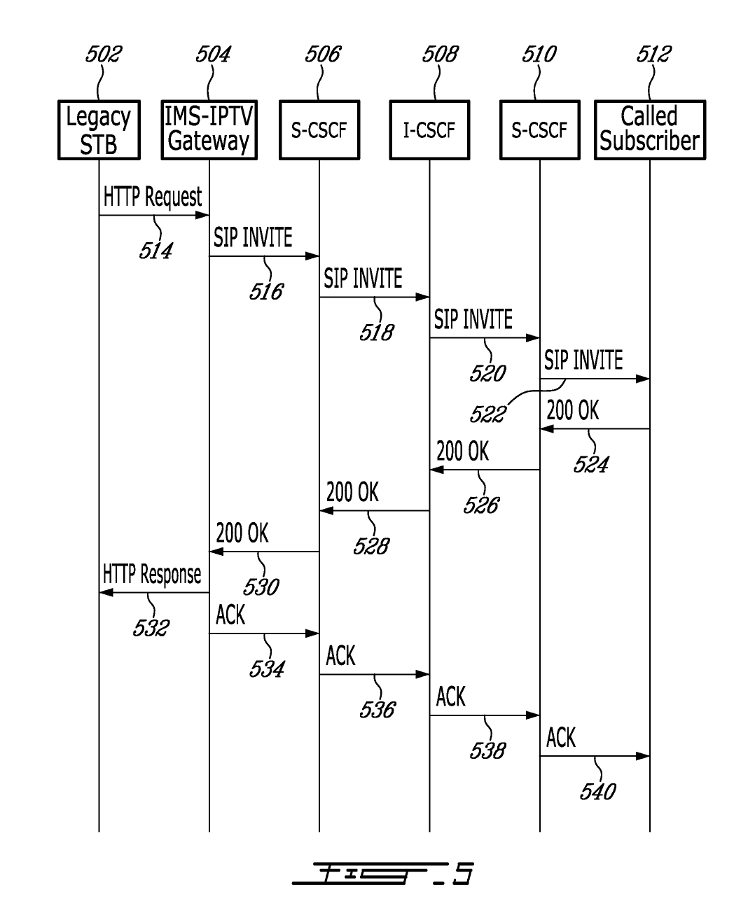

To notify the legacy STB 402 of successful registration within the IMS network 226, the S-CSCF 414 transmits a 200 OK message 436 to the P/I-CSCF 410. The P/I-CSCF 410 then transmits a 200 OK message 438 to the IMS/IPTV gateway 406. As previously described, the received IMS identity is linked to an identifier for the legacy STB 402. Based upon this information, the IMS/IPTV gateway 406 transmits an HTTP response message 440 to the proxy/AS 404 which in turns proxies the response 442 to the legacy STB 402 informing the legacy STB 402 of successful registration with the IMS network 226. Upon the completion of this successful registration, as illustrated in the exemplary embodiment described in FIG. 4, the user can access services, as well as receive services associated with an IMS system. For that purpose, the IMS/IPTV gateway 406 creates a record for legacy users that have successfully registered in the IMS network. These records store pertinent information, e.g., identities, etc., used during traffic to/from those users. The record is deleted if the legacy user deregisters or if a registration times-out. Various exemplary services and their associated call flows will be described below with respect to FIGS. 5-8.

According to exemplary embodiments, FIG. 5 illustrates an exemplary sequence of messages to be used to make a voice over IP (VoIP) call from a legacy STB 502 (which is already registered with the IMS network 226) to a subscriber device 512 associated with an IMS network 226. Initially, the legacy STB 502 transmits a HTTP request message 514 which includes, among other possible information, the destination address, the user's own identity and the media address for forwarding the real time transport protocol (RTP), to the IMS/IPTV gateway 504. Additionally, other information that may also be important for completing the call may be included in the HTTP request. The HTTP request message goes through a proxy/AS 304 (not shown in this call flow) for authorization and forwarding in a manner similar to that described above in FIG. 4 for registration. Upon receipt of the HTTP request message 514, the IMS/IPTV gateway 504 fetches the IMS identity, as previously described above, or by retrieving the subscriber registration record that was created after successful registration, and fetching the IMS identity stored therein, and transmits a SIP INVITE message 516 to the S-CSCF 506. The S-CSCF 506 then forwards the SIP INVITE message 518, by using standard IMS routing techniques to the I-CSCF 508 which is part of the terminating domain of the called subscriber 512. The I-CSCF 508 then forwards the SIP INVITE message 520 to the S-CSCF 510 which is also within the terminal domain of the called subscriber 512. The S-CSCF then forwards a SIP INVITE message 522 to the called subscriber 512.

Upon receipt of the SIP INVITE message 522, the called subscriber 512 transmits a 200 OK message 524 to accept the call back to the S-CSCF 510. The S-CSCF 510 then sends the 200 OK message 526 to the I-CSCF 508. The I-CSCF 508 then sends the 200 OK message 528 to the S-CSCF 506, which in turn sends the 200 OK message 530 to the IMS/IPTV gateway 504. The IMS/IPTV gateway 504 then transmits an HTTP response message 532 to the legacy STB 502, via the proxy/AS 304 (not shown in this call flow), indicating that the call has been accepted by the called subscriber 512. Additionally, the IMS/IPTV gateway 504 transmits an ACK message, as shown by ACK messages 534, 536, 538 and 540, to the called subscriber 512. At this point the VoIP call may occur between the legacy STB 502 and the called subscriber 512.

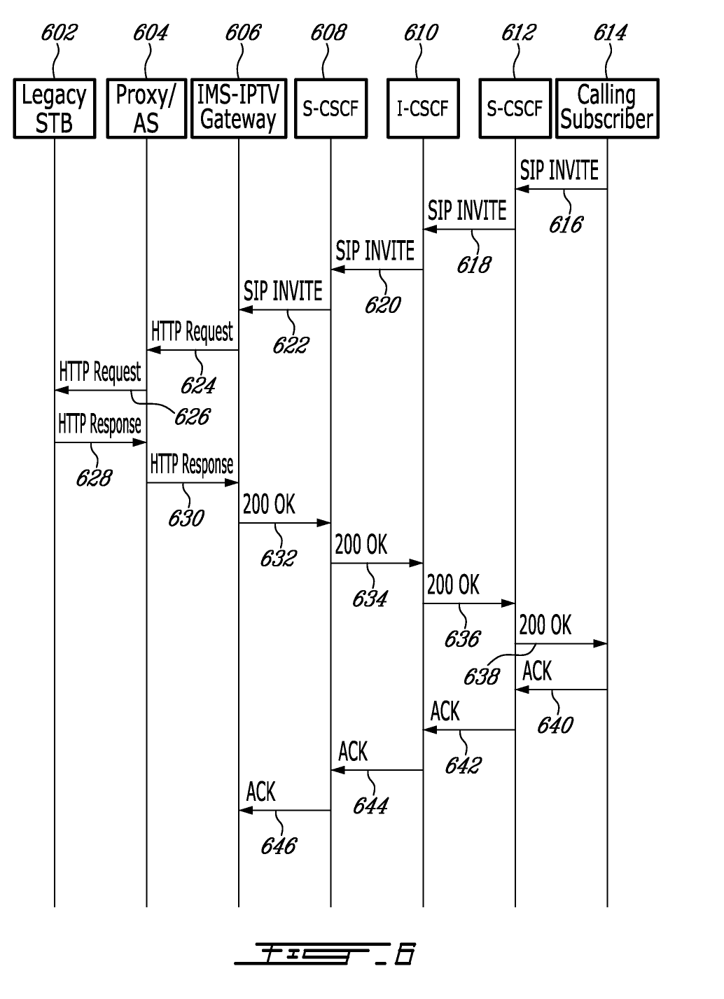

FIG. 6 illustrates an exemplary sequence of messages used when legacy STB 602 receives a VoIP call from a calling subscriber 614 which is an IMS user. Initially, a SIP INVITE message 616 is transmitted from the called subscriber 614 to a S-CSCF 612 of the originating domain. The S-CSCF 612 forwards the SIP INVITE message 618 to an I-CSCF 610 within the terminating domain using normal IMS routing techniques. The I-CSCF 610 then forwards the SIP INVITE message 620 to an S-CSCF 608 that is also within the terminating domain. The S-CSCF 608 then forwards the SIP INVITE message 622 to the IMS-IPTV gateway 606 which then fetches the IPTV identity, e.g. the URI of the legacy user, which is associated with the received IMS identity in the SIP INVITE message 622. The IMS-IPTV gateway 606 then transmits a HTTP request 624 which contains the request for an incoming call, the media address and the calling number to the proxy/AS 604. The proxy/AS 604 then forwards the HTTP request 626 to the legacy STB 602.

The legacy STB 602 responds to the HTTP request 626 and transmits a HTTP response message 628 to indicate call acceptance and which includes a media address for receiving the RTP packets to the proxy/AS 604. The proxy/AS 604 then forwards the HTTP response message 630 to the IMS-IPTV gateway 606. Since the IMS-IPTV 606 “remembers” the appropriate IMS identity, e.g., by locally caching the IMS identity when it was fetched in response to signal 622, fetching from the DB 322 is not required. The IMS-IPTV gateway 606 then transmits a 200 OK message 632 which includes the media address received in the HTTP response message 630 to the S-CSCF 608 of the terminating domain. The S-CSCF 608 then sends the 200 OK message 634 to the I-CSCF 610. The I-CSCF 610 sends the 200 OK message 636 to the S-CSCF 612 of the originating domain. The S-CSCF 612 sends the 200 OK message 638 to the calling subscriber 614 which originated the call. Upon receipt of the 200 OK message 638, the calling subscriber 614 transmits an ACK message to the IMS-IPTV gateway 606 as shown by ACK messages 640, 642, 644 and 646.

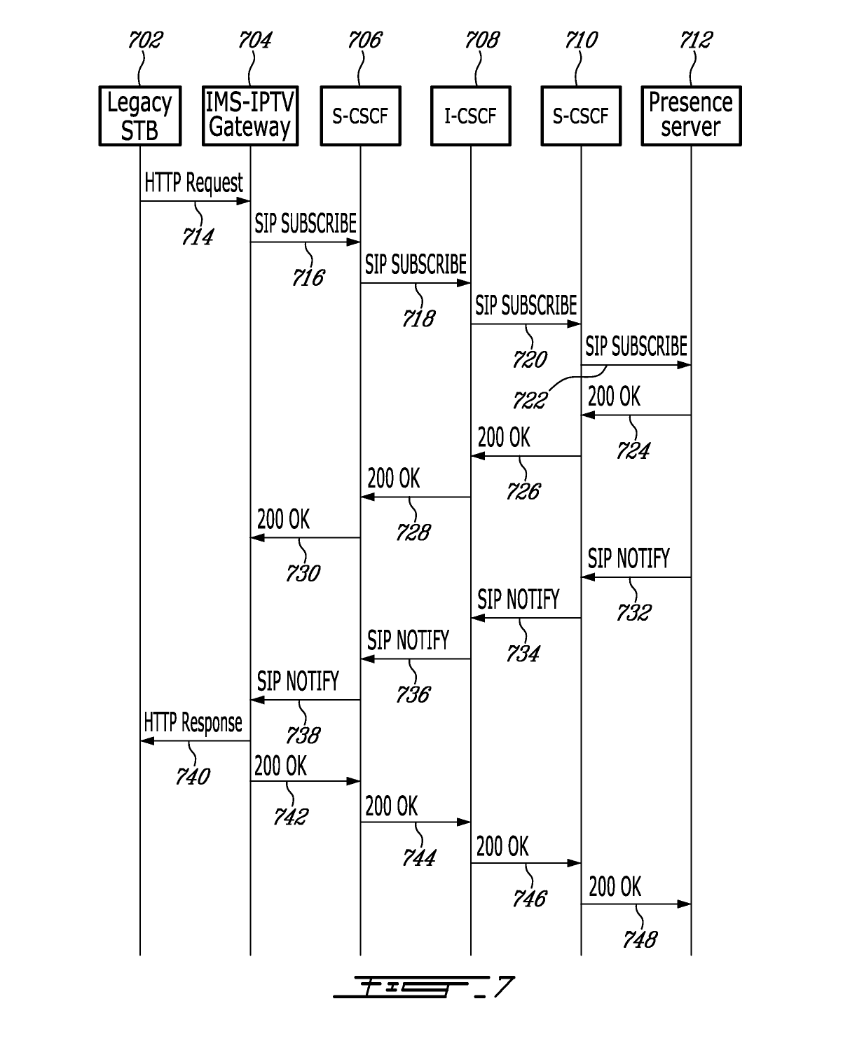

FIG. 7 illustrates an exemplary sequence of messages used when an IPTV user wants to subscribe to the presence of an IMS user, i.e., to be informed when an IMS user is online. Initially, the legacy STB 702 transmits a HTTP request message 714, which includes information requesting presence status of a subscriber, as well as the identity of the target subscriber, to the IMS-IPTV gateway 704. The messages shown as being transmitted between the legacy STB 702 and the IMS-IPTV gateway 704 will typically be routed through the proxy/AS 304, which is not shown in this exemplary call flow diagram. Upon receipt of the HTTP request message 714, the IMS-IPTV gateway 704 fetches the IMS identity for the originating user and then transmits a SIP SUBSCRIBE message 716 to the S-CSCF 706 of the originating domain. The S-CSCF 706 transmits a SIP SUBSCRIBE message 718 to the I-CSCF 708 in the terminating domain using standard IMS routing principles. The I-CSCF 708 forwards the SIP SUBSCRIBE message 720 to the S-CSCF 710 which is also in the terminating domain. The S-CSCF 710 forwards the SIP SUBSCRIBE message 722 to the presence server 712 of the target IMS user based on the user profile and using standard IMS procedures. Acknowledgement of the SUBSCRIBE request is transmitted from presence server 712 back to the IMS-IPTV gateway 704 as shown by the sequence of 200 OK messages 724, 726, 728 and 730.

After the transmission of the 200 OK messages 724, 726, 728 and 730, the presence server 712 typically transmits a SIP NOTIFY message 732 which contains its current state information regarding the subscriber to the S-CSCF 710 in the terminating domain. The S-CSCF 710 sends the SIP NOTIFY message 734 to the I-CSCF 708. The I-CSCF 708 then sends the SIP NOTIFY message 736 to the S-CSCF 706 in the originating domain. The S-CSCF 706 then sends the SIP NOTIFY message 738 to the IMS-IPTV gateway 704. The IMS-IPTV gateway 704 sends a HTTP response message 740 which contains the current state information of the presence server 712 to the legacy STB 702. Additionally, acknowledgement of the SIP NOTIFY 738 message is transmitted from the IMS-IPTV gateway 704 to the presence server 712 as shown by the 200 OK messages 742, 744, 746 and 748.

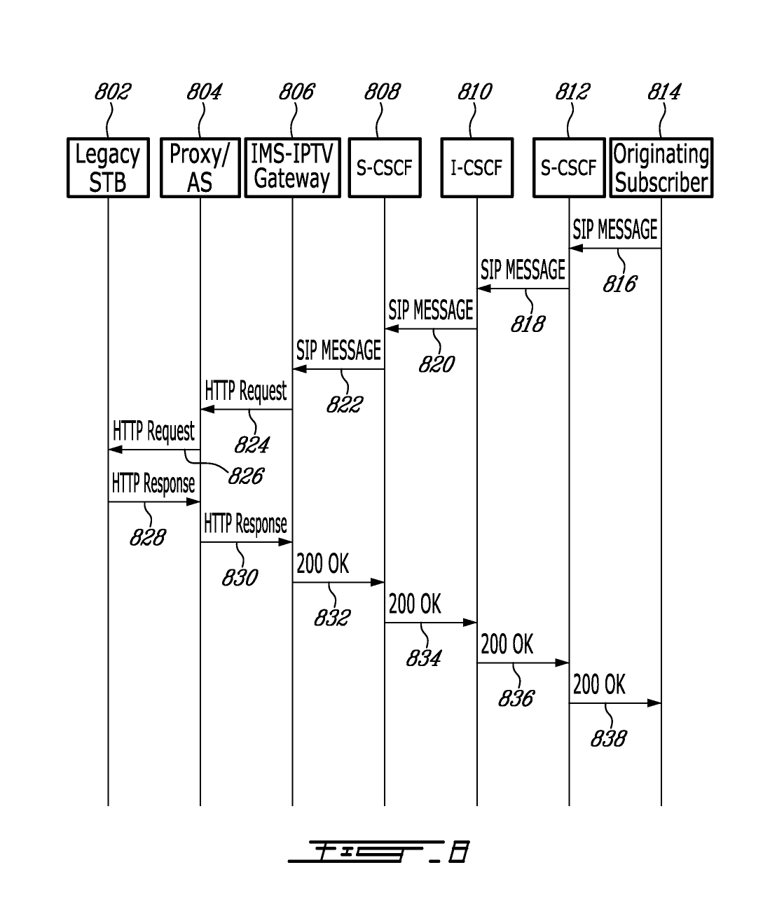

FIG. 8 illustrates an exemplary sequence of messages used when an IPTV user associated with a non-IMS network receives the contents of an incoming SIP MESSAGE from an IMS user. Initially, the originating subscriber 814 transmits a SIP MESSAGE 816 to the S-CSCF 812 in the originating domain. The S-CSCF 812 then sends the SIP MESSAGE 818 to the I-CSCF 810 in the terminating domain. The I-CSCF 810 sends the SIP MESSAGE 820 to the S-CSCF 808 which is also in the terminating domain. The S-CSCF 808 sends the SIP MESSAGE 822 to the IMS-IPTV gateway 806, where the IMS-IPTV gateway 806 fetches the IPTV identity of the legacy user associated with the IMS identity included in SIP MESSAGE 822. The IMS-IPTV gateway 806 transmits a HTTP request message 824 which contains the relevant contents of SIP MESSAGE 822 to the proxy/AS 804. The proxy/AS 804 then forwards the HTTP request message 826 to the legacy STB (user) 802. Upon receipt of the HTTP request message 826, the legacy STB 802 transmits a HTTP response message 828 indicating successful receipt of the message contents from target subscriber 814 to the proxy/AS 804, which forwards the HTTP response message 830 to the IMS-IPTV gateway 806. The IMS-IPTV gateway 806 notifies the originating subscriber 814 of successful receipt of the message by the legacy STB (user) 802 by transmitting a 200 OK message to the originating subscriber 814 as shown by 200 OK messages 832, 834, 836 and 838.

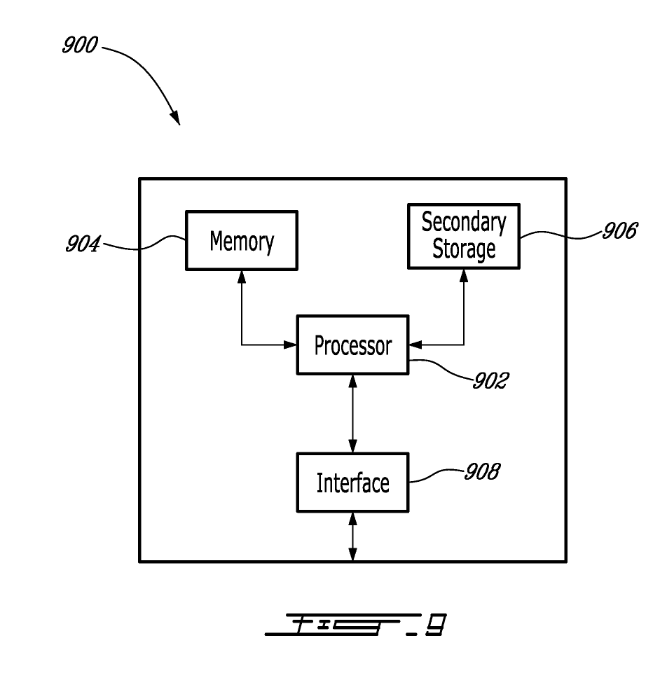

The exemplary embodiments described above provide for messages and protocols involving person to person communications. An exemplary communications node 900 will now be described with respect to FIG. 9. Communications node 900 can contain a processor 902 (or multiple processor cores), a memory 904, one or more secondary storage devices 906 and an interface unit 908 to facilitate communications between communications node 900 and other networks and devices. Additionally, the communications node 900 can contain logic and protocols to allow the communications node to act as an IMS-IPTV gateway. Alternatively, the communications node 900 could act as a proxy node or as an application server.

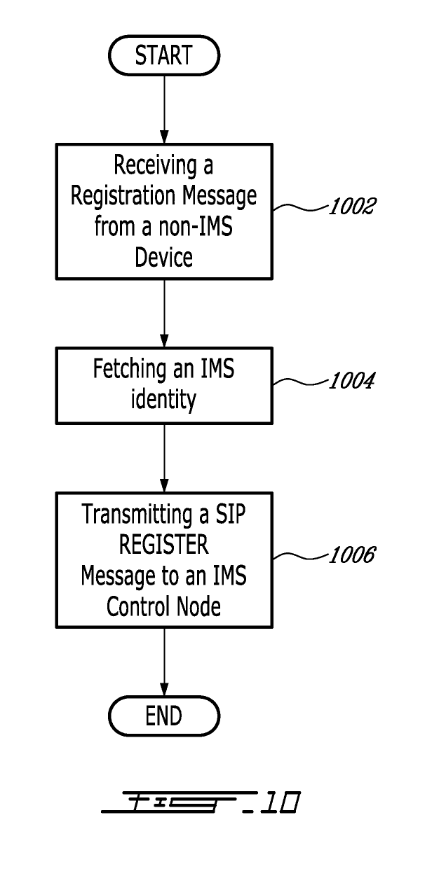

Utilizing the above described exemplary systems according to exemplary embodiments, a method for communicating between an IMS device and a non-IMS device is shown in the flow chart of FIG. 10. Initially, a gateway node receives a registration message from a non-IMS device in step 1002. The gateway node then fetches an IMS identity in step 1004. Upon receiving the IMS identity, the gateway node transmits a SIP REGISTER message to an IMS control node in step 1006.

The above-described exemplary embodiments are intended to be illustrative in all respects, rather than restrictive, of the present invention. All such variations and modifications are considered to be within the scope and spirit of the present invention as defined by the following claims. For example, the IMS identities/non-IMS identity pairs may be static and populated in DB 322 or may be dynamically assigned. Additionally, the exemplary services described above are purely illustrative and other IMS services can be supported through the above described systems and methods. No element, act, or instruction used in the description of the present application should be construed as critical or essential to the invention unless explicitly described as such. Also, as used herein, the article “a” is intended to include one or more items.

What is claimed is:

1. A method for communicating between an IP Multimedia Subsystem (IMS) device and a non-IMS device comprising:
receiving, at a gateway node, a registration message from said non-IMS device;
fetching an IMS identity; and
transmitting a session initiation protocol (SIP) REGISTER message toward an IMS control node.

2. The method of claim 1, wherein said fetching said IMS identity further comprises:
requesting said IMS identity from a database, wherein said request includes a unique identifier for said non-IMS device; and
receiving said IMS identity, which is related to said identifier, for said non-IMS device from said database.

3. The method of claim 2, wherein said identifier for said non-IMS device is a uniform resource identifier (URI).

4. The method of claim 1, further comprising:
receiving a 200 OK message from a node in an IMS-Internet Protocol television (IPTV) system; and
transmitting a 200 OK message to a proxy node in a non-IMS-IPTV system.

5. The method of claim 4, wherein said non-IMS-IPTV device utilizes HTTP signaling and said IMS-IPTV device utilizes SIP signaling.

6. A gateway node comprising:
a memory for storing IP Multimedia Subsystem (IMS) identities;
a communication interface for receiving messages from other nodes; and
a processor in communication with said memory and said communication interface, wherein said gateway node receives a registration message associated with a non-IMS device, fetches an IMS identity associated with said non-IMS device, and transmits a session initiation protocol (SIP) REGISTER message.

7. The gateway node of claim 6, wherein said gateway node is an IMS-Internet Protocol television (IPTV) gateway node.

8. The gateway node of claim 6, wherein said registration message is a hypertext transfer protocol (HTTP) message.

9. The gateway node of claim 6, wherein said processor fetches said IMS identity by requesting said IMS identity from a database, wherein said request includes a unique identifier for said non-IMS device and receiving said IMS identity, which is related to said identifier, for said non-IMS device from said database.

10. The gateway node of claim 9, wherein said identifier for said non-IMS device is a uniform resource identifier (URI).

11. A method for initiating an IP Multimedia Subsystem (IMS) service from a non-IMS device, comprising:
receiving, at a gateway node, a hypertext transfer protocol (HTTP) request message for said IMS service from said non-IMS device;
fetching an IMS identity associated with said non-IMS device;
transmitting a session initiation protocol (SIP) message requesting said IMS service toward an IMS device;
receiving a SIP message from said IMS device;
transmitting a hypertext transfer protocol (HTTP) response message indicating acceptance of said IMS service request toward said non-IMS device; and
transmitting an acknowledgement message toward said IMS device.

12. The method of claim 11, wherein said IMS service is a voice over IP (VoIP) call.

13. The method of claim 11, wherein said HTTP request message contains a destination address and a media address.

14. A method for receiving a message from an IP Multimedia Subsystem (IMS) device by a non-IMS device comprising:
receiving, at a gateway node, a first session initiation protocol (SIP) message call from said IMS device;
fetching a non-IMS identity associated with said non-IMS device;
transmitting a hypertext transfer protocol (HTTP) request message including contents of said SIP message toward a non-IMS device;
receiving a HTTP response message indicating successful receipt from said non-IMS device; and
transmitting a second SIP message indicating said successful receipt toward said IMS device.

15. The method of claim 14, wherein said first SIP message includes information for initiating a voice over IP (VoIP) call and said second SIP message includes acceptance of said VoIP call.

16. The method of claim 14, further comprising:
receiving at said gateway node an acknowledgement message from said IMS device.

17. A method for requesting presence information from a non-IP Multimedia Subsystem (IMS) device regarding an IMS device comprising:
receiving at a gateway node, a hypertext transfer protocol (HTTP) request message for said presence information from said non-IMS device;
fetching an IMS identity associated with said non-IMS device;
transmitting a session initiation protocol (SIP) message requesting said presence information toward said IMS device;
receiving a first SIP message indicating acknowledgement of said requesting from said IMS device;
receiving a second SIP message including said presence information from said IMS device;
transmitting an HTTP response message including said presence information to said non-IMS device; and
transmitting an acknowledgement message toward said IMS device.

18. A gateway node for providing IP Multimedia Subsystem (IMS) services to legacy users comprising:
a gateway logic for receiving a request for an IMS service from a legacy user;
a web access interface capable of forwarding said request toward a first IMS application server; and
an IMS access interface capable of forwarding said request toward a second IMS application server;
wherein said gateway logic selectively uses one of said web access interface and said IMS access interface to forward said request.

19. The gateway node of claim 18, wherein said web access interface forwards said request using a hypertext transfer protocol (HTTP) bearer toward a web service access portal.

20. The gateway node of claim 18, wherein said web access interface forwards said request using an HTTP bearer toward a web access/IMS access portal.

21. The gateway node of claim 18, wherein said IMS access interface forwards said request using a session initiation protocol (SIP) bearer toward an IMS core network.
